(19) United States
(12) Patent Application Publication
(10) Pub. No.: US 2010/0305851 A1
(43) Pub. Date: Dec. 2, 2010

(54) DEVICE AND METHOD FOR UPDATING CARTOGRAPHIC DATA

(75) Inventors: Steffen Meyer, Erlangen (DE); Juergen Hupp, Nuernberg (DE); Thorsten Vaupel, Hornberg (DE)

Correspondence Address: SCHOPPE, ZIMMERMANN , STOCKELER & ZINKLER;C/O KEATING & BENNETT, LLP, 1800 Alexander Bell Drive, SUITE 200, Reston, VA, 20191, US

(73) Assignee: Fraunhofer-Gesellschaft zur Foerderung der angewandten Forschung e.V., Munich (DE)

(21) Appl. No.: 12/679,044

(22) PCT Filed: Sep. 19, 2008
(86) PCT No.: PCT/EP08/07914

§ 371 Date: Apr. 19, 2010

(30) Foreign Application Priority Data
Sep. 21, 2007 (DE) 10 2007 045 082.8

(51) Int. Cl. G01C 21/00

(52) U.S. Cl. 701/208

(57) ABSTRACT

A device for updating cartographic data for a predetermined region, having a collector for collecting location information of a path covered in the predetermined region, an overlayer for overlaying the collected location information with the cartographic data for the predetermined region, a determiner for determining portions contradictory or missing in the cartographic data for the predetermined region on the basis of the overlaid collected location information, and an updater for updating the cartographic data in the missing or contradictory portions on the basis of the overlaid collected location information.

### BACKGROUND OF THE INVENTION

The present invention relates to devices and methods for updating cartographic data, particularly for updating digital cartographic data.

Location technologies have begun to become widespread at a very quick pace with the introduction of GPS (Global Positioning System). The GPS system enables a position, particularly on the earth's surface, to be determined with high precision and in a user-friendly way. Opening up the accuracy of the GPS system for private purposes and miniaturization and improved mobility of the terminal devices have made its wide acceptance and use increase further.

Upon reaching a critical mass of users and applications, ongoing integration of location technologies into mass products, such as SmartPhones or PDAs (PDA=Personal Digital Assistant) and development of relevant, location-related services now lead to further distribution. Cartographic information meanwhile available in various forms, only now allowing for reasonable application of location technologies, plays an equally important role in this development.

Generating cartographic material is an intensive procedure. Various sources serve as a basis, such as data of administrative instances under public law for exterior or outdoor areas and data from architects for interior or indoor areas. Generating is effected depending on application, level of detail, location technology and requirements, on a partially automated or manual basis. Creating and importing existing data is supplemented by targeted manual measurement value pickup. One example is systematically driving through streets with logging systems for map creation.

So as to reduce this creation effort and also take the constant changes of the environment into account, a appropriate approach is needed. Likewise, there may be provided a methodology to be able to integrate areas that are not, or imprecisely, captured when relevant, or utilized, or also incorporate additional information.

Another aspect is the inclusion of data not represented in classic geo-information systems (GIS) and concerning e.g. the behaviour of people or the usability of elements (areas, buildings, etc.). This necessitates the creation of corresponding instances collecting this information, evaluating the same, and suitably supplementing the database.

In conventional technology, there are known many ways that can be taken for creating cartographic material for location applications. The most basic, but also most intensive way is taken by public administration instances, which perform far-reaching manual measurements with terrestrial or astronomic reference points (e.g. stars, satellites). This is a requirement, for hardly any alternative methods were possible historically and legal stability shall be guaranteed. Apart from the initial creation, particularly the update of the cartographic data means a great effort, so that known and unknown changes of the real word are worked into the cartographic material successively and with a partly enormous use of resources. These maps may be supplemented by information of other dimensions, such as statistical or behavioural data, street networks etc. Such logic information does not, however, result in changes of a cartographic database itself, but has the character of additional views.

These sources of cartographic starting material are partially supplemented by a specialized content provider. On the one hand, geo-information systems (GIS) under public law are used to this end. Here, a geo-information system is a computer-aided information system consisting of hardware, software, data and the applications. Therewith, space-related data may be digitally captured and edited, stored and reorganized, modelled and analysed, as well as presented alphanumerically and graphically. Additionally, specialized content providers, however, focus on creating databases of their own. To this end, for example, vehicles are equipped with (several) high-quality GPS receivers, and systematic measurement drives performed in the street network of the operating area. This also a very intensive method rather serves for capturing and providing information on trafficable streets and paths supplemented by additional information (e.g. one-way streets, stops) and buildings without detail. The problem of keeping the cartographic data up to date and adapted to changes in reality also occurs here.

### SUMMARY

According to an embodiment, a device for updating cartographic data for a predetermined region may have: a collector for collecting location information of a path covered in the predetermined region, wherein the collector is formed to provide the collected location information with reliability information; an overlayer for overlaying the collected location information with the cartographic data for the predetermined region, wherein the overlayer is formed to weight the location information that corresponds to the paths covered corresponding to selectable criteria, wherein each coordinate of the location information is weighted with a location unsharpness function for weighting to acquire a location probability statement in form of an unsharpness corridor corresponding to the path covered; a determiner for determining portions contradictory or missing in the cartographic data for the predetermined region on the basis of the overlaid collected location information, wherein the determiner is formed to determine similar paths deviating from each other by a maximum tolerance range admissible from collected location information corresponding to a plurality of paths covered, and wherein contiguous regions are determined by overlaying unsharpness corridors corresponding to the similar paths and ensuing edge detection; and an updater for updating the cartographic data in the missing or contradictory portions on the basis of the overlaid, collected location information.

According to another embodiment, a method of updating cartographic data for a predetermined region may have the steps of: collecting location information of a path covered in the predetermined region, wherein the collected location information is provided with reliability information; overlaying the collected information with the cartographic data for the predetermined region, wherein the location information that corresponds to a path covered is weighted corresponding to the reliability information, wherein each coordinate of the location information is weighted with a location unsharpness function for weighting to acquire a location probability statement in form of an unsharpness corridor corresponding to the path covered; determining portions contradictory or missing in the cartographic data for the predetermined region on the basis of the overlaid, collected location information, wherein similar paths deviating from each other by a maximum tolerance range admissible are determined from location information corresponding to a plurality of paths covered, and wherein contiguous regions are determined by overlaying unsharpness corridors corresponding to the similar paths and ensuing edge detection; and updating the cartographic data in the missing or contradictory portions on the basis of the overlaid collected location information.

According to another embodiment, a computer program may perform, when the computer program is executed on a computer and/or microcontroller, a method of updating cartographic data for a predetermined region, wherein the method may have the steps of: collecting location information of a path covered in the predetermined region, wherein the collected location information is provided with reliability information; overlaying the collected information with the cartographic data for the predetermined region, wherein the location information that corresponds to a path covered is weighted corresponding to the reliability information, wherein each coordinate of the location information is weighted with a location unsharpness function for weighting to acquire a location probability statement in form of an unsharpness corridor corresponding to the path covered; determining portions contradictory or missing in the cartographic data for the predetermined region on the basis of the overlaid, collected location information, wherein similar paths deviating from each other by a maximum tolerance range admissible are determined from location information corresponding to a plurality of paths covered, and wherein contiguous regions are determined by overlaying unsharpness corridors corresponding to the similar paths and ensuing edge detection; and updating the cartographic data in the missing or contradictory portions on the basis of the overlaid collected location information.

The present invention is based on the finding that currently available location systems allow for logging and further processing, in a centralized or local manner, information on a history of determined positions of mobile units. By way of logging, sequences of determined positions of mobile subscribers of a location system can be generated. A temporal or spatial reference of these determined positions with respect to each other and among these dimensions (time, space) allows for representing a path covered of a mobile unit. The ways or paths covered of the mobile units can be collected and processed further, in order to link them with the existing information and/or cartographic data on the corresponding surroundings.

At first, for example, rendition of the determined positions and/or collected location information of a mobile unit takes place, maybe normalization of geographic and temporal kind, assessment regarding source and/or quality and maybe further steps, depending on the embodiments of the present invention. Subsequently, the location information thus collected may be analyzed by grouping typical paths covered with a certain parameterization and identifying the same. Quantities of influence may here be e.g. a number of paths, velocity, direction and/or path profile, location technology, spatial and temporal distance. Thus, paths can be recognized and marked in a predetermined region and/or area in an adjustable manner within certain boundaries and sharpnesses, whereupon classification may take place, which assesses the determined character of the paths covered with respect to their repercussions on the cartographic data. The classification serves as a basis for representing newly acquired information in a database in various ways. For example, it may thus be determined whether a street is modeled with a certain basic extension, or a footpath as an unstructured passable area. Reliability of the new cartographic data may also be logged and serve as an indication of their origin for further processing.

Embodiments of the present invention to this end provide a device for updating cartographic data for a predetermined region, having means for collecting location information of a path covered in the predetermined region, means for overlaying the collected location information with the cartographic data for the predetermined region, means for determining portions contradictory or missing in the cartographic data for the predetermined region on the basis of the overlaid collected location information, and means for updating the cartographic data in the missing or contradictory portions on the basis of the overlaid, collected location information.

In embodiments of the present invention, the cartographic data are digital cartographic data, in particular, such as digital photographs of landscapes, such as satellite photographs, or CAD (computer-aided design) data for indoor areas of buildings.

In embodiments of the present invention, the location information is determined on the basis of radio signals. This may be radio signals from satellite-assisted location and/or navigation systems, but also radio signals from RFID (radio frequency identification) systems, IEEE802.11 WLANs (wireless local area networks) or other common mobile radio networks, for example based on GSM (global system for mobile communications), UMTS (universal mobile telecommunication system), OFDM (orthogonal frequency division multiplex) and further standards (e.g. DECT, Bluetooth, . . . ).

One advantage of the present invention consists in the fact that an already existing general distribution of mobile units for location information detection is used for updating the cartographic data. Components of location technologies (hardware and software) have become mass products and integrated in a multiplicity of various commercially available terminal devices of diverse price classes. This has led to widespread, continuous use in every day life, which is no longer exclusive to survey institutions or commercial users. Thus, cartographic data may be generated and/or updated by recording paths covered of mobile units with a high level of detail by means of embodiments of the present invention.

Other elements, features, steps, characteristics and advantages of the present invention will become more apparent from the following detailed description of the preferred embodiments with reference to the attached drawings.

### BRIEF DESCRIPTION OF THE DRAWINGS

Embodiments of the present invention will be detailed subsequently referring to the appended drawings, in which:

FIG. 1 is a block diagram of a device for updating cartographic data, according to an embodiment of the present invention;

FIG. 2 is a flowchart for illustrating a method of updating cartographic data, according to an embodiment of the present invention;

FIG. 3ais a flowchart for explaining the collection of location information of paths covered in a predetermined region, according to an embodiment of the present invention;

FIG. 3b is a flowchart of overlaying the collected location information with existing cartographic data and of determining portions contradictory or missing in the cartographic data for the predetermined region on the basis of the overlaid collected location information, according to an embodiment of the present invention;

FIG. 3c is a flowchart of an update of the cartographic data, according to an embodiment of the present invention;

FIG. 4 is a schematic illustration for explaining collecting the location information, according to an embodiment of the present invention;

FIGS. 5a,b are possible illustrations of location information, according to embodiments of the present invention;

FIG. 6 is an illustration for explaining filtering location information, according to an embodiment of the present invention;

FIG. 7 is a schematic illustration for explaining determining missing or contradictory map portions, according to an embodiment of the present invention;

FIG. 8 is a schematic illustration of two different paths weighted on the basis of reliability information;

FIG. 9 is an illustration of different weighting functions, according to embodiments of the present invention;

FIG. 10 is an illustration of different paths and/or coordinate profiles resulting from different weightings;

FIG. 11 is an illustration of photographic cartographic material overlaid with location information, according to an embodiment of the present invention;

FIG. 12 is an overlay of location information of a plurality of similar paths covered; and

FIG. 13 is an overview diagram for illustrating the functioning of embodiments of the present invention.

### DETAILED DESCRIPTION OF THE INVENTION

Regarding the subsequent description, it is to be noted that the same or similarly acting functional elements have the same reference numerals in the different embodiments, and hence the descriptions of these functional elements are mutually interchangeable in the various embodiments illustrated in the following.

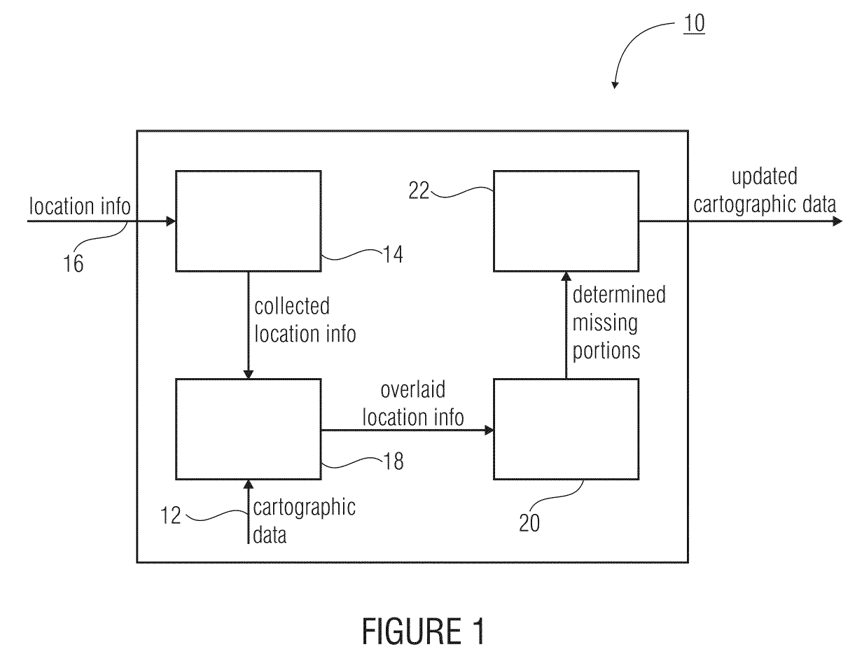

FIG. 1 shows a schematic block diagram of a device 10 for updating cartographic data 12 for a predetermined region.

The device 10 includes means 14 for collecting location information 16 of a path covered in the predetermined region. The means 14 for collecting is coupled to a means 18 for overlaying the collected location information with the cartographic data 12 for the predetermined region. Furthermore, the device 10 includes means 20 for determining portions contradictory or missing in the cartographic data 12 for the predetermined region on the basis of the overlaid, collected location information. Coupled to the means 20 for determining, there is means 22 for updating the cartographic data 12 in the missing or contradictory portions on the basis of the overlaid, collected location information.

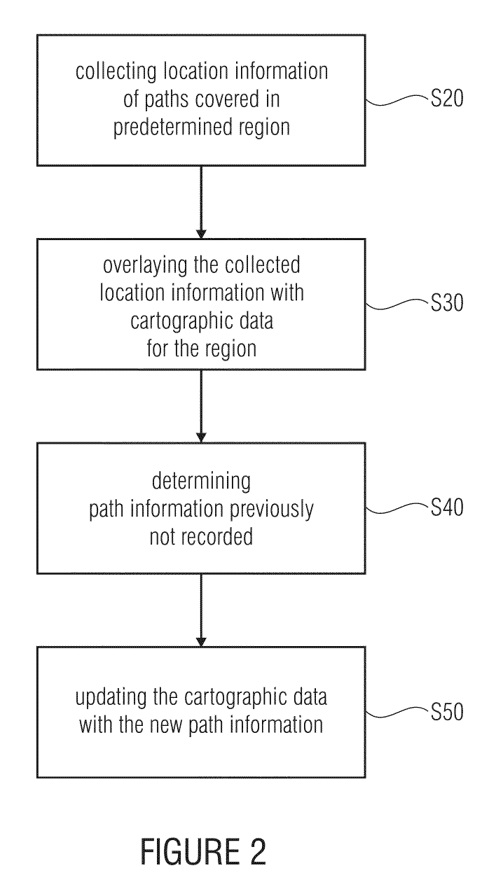

The functioning of the device 10 for updating the cartographic data 12, as schematically shown in FIG. 1, will be explained in greater detail in the following on the basis of FIGS. 2-12.

FIG. 2 shows a flowchart for illustrating the flow of a method of updating the cartographic data 12, according to an embodiment of the present invention.

In a first step, S20, the location information 16 is collected in the predetermined region. Various position finding and/or location technologies may form the basis here. The probably best-known system for location and/or navigation in the outdoor area is satellite-assisted GPS. For the location and/or navigation within buildings and/or in an indoor area, infrared systems, RFID systems or WLAN systems may be employed, for example. At present, GPS is available in a reliable manner for the outdoor area only. More recent extensions, such as highly sensitive receivers or A-GPS (assisted GPS), as it is called, represent attempts to make the technology usable also within buildings. A-GPS here combines the use of satellite-based GPS with the reception of so-called assistance information from cellular mobile networks. For location within buildings or within a relatively small, confined outside area, radio systems on the basis of the WLAN standard suggest themselves, for example. Here, a WLAN-based location determination may, for example, be realized by way of a kind of RF (radio frequency) fingerprint, wherein a corresponding radio receiver records electromagnetic properties of its surroundings, such as reception field strength level, wherein a relatively exact position to the radio receiver can be derived therefrom.

Provided that a (mobile) localizing subscriber device has map and reference information and measurement values of sensors, in particular, it can determine its own position. Without map and/or reference information, the measured values may, however, be transmitted to a location means capable of determining the position of the subscriber device from the measured values. For the step S20 of collecting the location information, it is irrelevant which technology the position determination is based on and whether it is carried out in a local, central or any hybrid way. It is only relevant that position finding is continuous. This means that when connecting the position information, position determination and maybe position output are executed in a generally cyclical manner and not triggered interactively by a user. Here, a frequency at which the position information 16 is determined is sufficiently high, so as to be able to offer a subscriber not too jumpy a presentation and ensure functioning of embodiments of the present invention, even at higher speeds of movement.

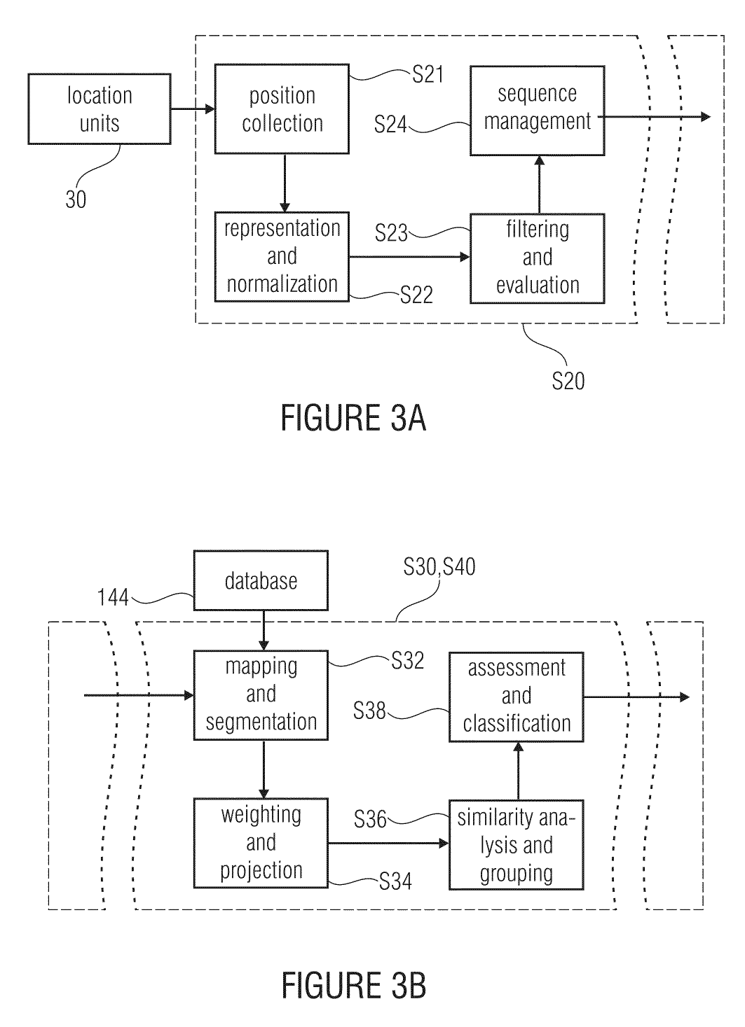

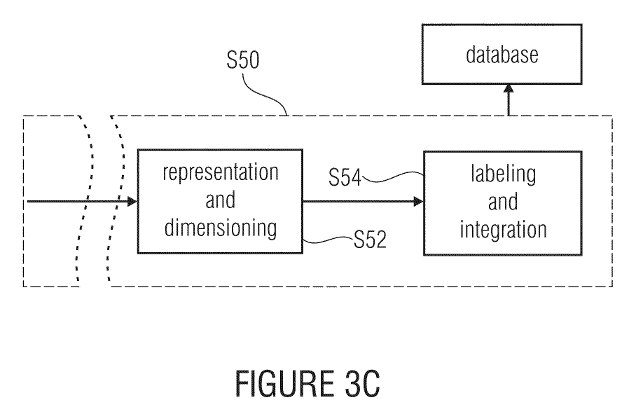

As schematically shown in FIG. 3a, in the step S20 of collecting the location information 16, i.e. in a step S21, a sequence of positions representing movement of a subscriber-specific device and/or a location unit is generated. Here, the generated sequence is supported at the determined and/or estimated locations.

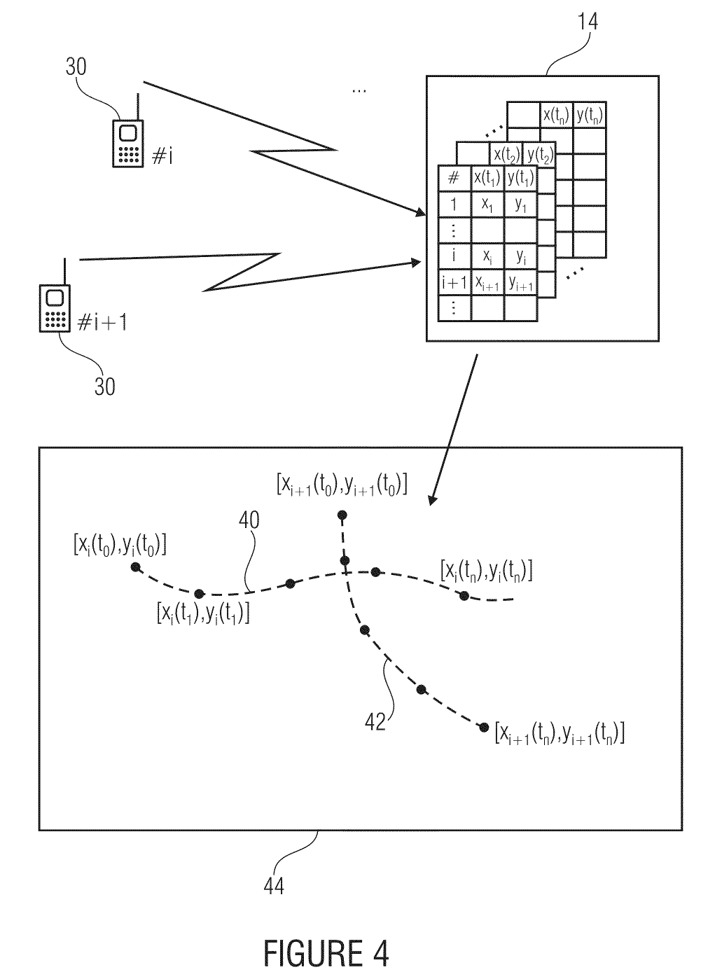

FIG. 4 exemplarily shows two mobile subscriber devices 30, each associated with a subscriber i and i+1 (i=0, 1, 2, . . . , I). The subscriber devices 30 each send their determined position information 16 to the means 14 for collecting. That is, the means 14 for collecting is coupled to transceivers of the mobile subscriber devices 30, according to embodiments. The subscriber-specific location information 16 includes, for a measurement time instant Tₙ (n=0, 1, 2, . . . , N), location coordinates xᵢ (tₙ), yᵢ (tₙ) and maybe zᵢ (tₙ) corresponding to height for three-dimensional representation. Furthermore, the location information 16 includes time information on the respective measurement time instant (n=0, 1, 2, . . . , N) and a transceiver tag of the respective subscriber device 30. A temporal lineup of the location information [(xᵢ (t₀), yᵢ (t₀)), . . . , (xᵢ (t_{N}), yᵢ (t_{N}))] and/or [xᵢ₊₁ (t₀), yᵢ₊₁ (t_{N}), yᵢ₊₁ (t_{N}))] corresponds to a path 40, 42 covered by the respective subscriber in a predetermined location region 44. The typical cartographic representations concern a two-dimensional region in the predetermined location region 44. Yet, applications of the present invention for three-dimensional location regions are also possible, of course.

The location information 16 generated by the mobile subscribers and/or their terminal devices 30 thus are present as a sequence of coordinates [(xᵢ (t₀), yᵢ (t₀)), . . . , (xᵢ (t_{N}), yᵢ (t_{N}))] and/or [xᵢ₊₁ (t₀), yᵢ₊₁ (t₀)), . . . , (xᵢ₊₁ (t_{N}), yᵢ₊₁ (t_{N}))] in the means 14 for collecting, according to embodiments.

With reference to FIG. 3a, the collected location information is suitably represented and normalized in a next sub-step S22. Here, the collected location information may, for example, be represented as position sequences or chains of vectors.

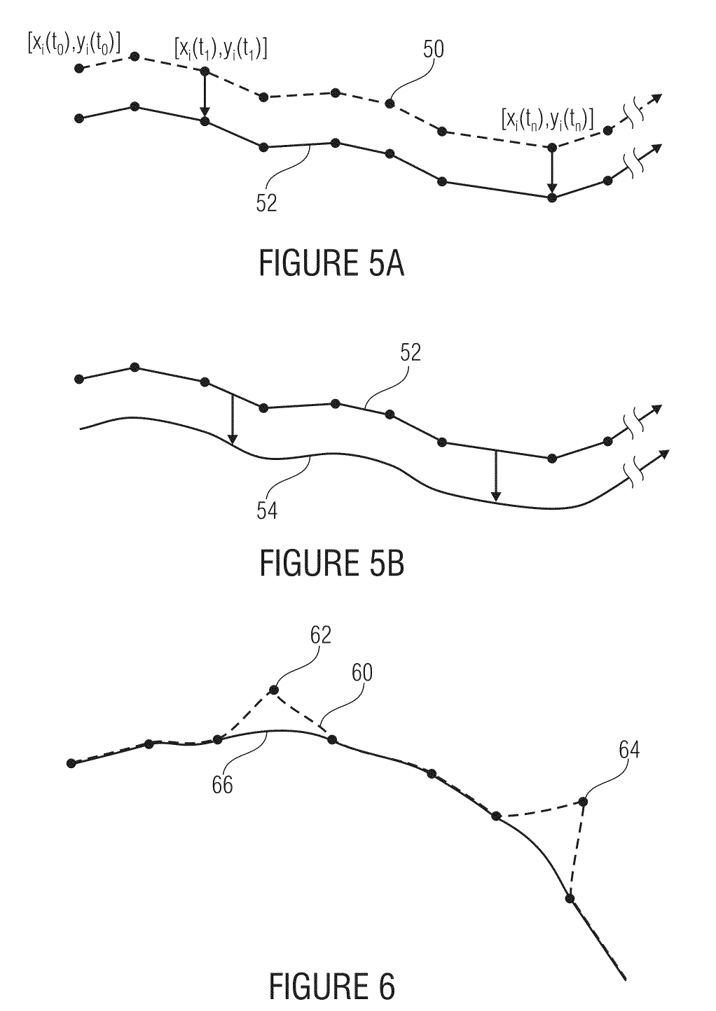

As illustrated in FIG. 5a, the location information 16, which originates from a subscriber i and/or the terminal device 30 thereof, is present as a sequence 50 of coordinates [(xᵢ(t₀), yᵢ(t₀)), . . . , (xᵢ(t_{N}), yᵢ(t_{N}))] after the sub-step S21. One way is to directly use this sequence 50 in order to identify popular, passable and reliably detected regions by way of a detection of position accumulations. In later views, however, a directional and temporal reference might be lost here, so that sequential modeling seems to make more sense for embodiments of the present invention. In this respect, a traverse 52 containing the determined positions [(xᵢ(t₀), yᵢ(t₀)), . . . , (xᵢ(t_{N}), yᵢ(t_{N}))] in a global and/or local coordinate system as support points is illustrated in FIG. 5a. Supplementation of the non-defined regions between the positions [(xᵢ(t₀), yᵢ(t₀)), . . . , (xᵢ(t_{N}), yᵢ(t_{N}))] by a connection of the positions by means of straight-line portions is characteristic. This procedure is suitable for complete histories of location information, but may also be performed for temporally and spatially limited regions.

Apart from this simple piece-wise interpolation by means of a traverse 52, also substantially more intensive methods can be used in embodiments of the present invention, to provide a continuous function describing a path covered from the discretely existing positional values [(xᵢ(t₀), yᵢ(t₀)), . . . , (xᵢ(t_{N}), yᵢ(t_{N}))]. Various mathematical approaches of different degrees can be applied, which are labeled exemplarily by reference numeral 54 in FIG. 5b. This higher-degree representation allows for, beyond numerical analyses, functional comparison with respect to grouping and similarity analysis. Loops in paths covered can be removed by way of corresponding detection in embodiments of the present invention.

In the sub-step S22, normalization of the collected location information might still be needed so as to produce comparability between paths covered by a plurality of different subscribers with different subscriber devices. Such normalization may, for example, take place when the different subscriber devices are based on different location technologies and communicate their positional and/or temporal data, e.g., in different data formats to the means 14 for collecting. Furthermore, it is conceivable that geographical position data (longitude and latitude indications) have to be converted to pixel coordinates. For example, this is the case when the cartographic data 12 for the predetermined location region are present as digital image data. Normalization in the sub-step S22 increases later comparability of different paths covered.

Collecting, S20, includes an improvement of the reliability of the collected location information by removing technology-induced errors, for example, by means of suitable filters, in a further sub-step S23 (FIG. 3a), according to embodiments. To this end, FIG. 6 shows a sequence 60 of location information representing a path covered of a subscriber i. Individual position data 62, 64, which do not represent an insignificant deviation from an assumed path 66 covered, are noticeable. In order to adapt the position sequence 60 to the assumed path 66 covered, the means 14 for collecting according to embodiments includes, e.g. a low-pass filter to smooth the position sequence 60 and, thus, adapt the positions 62 and 64 assumed to be faulty to the actual or more likely positions.

In the sub-step S23, the collected location information may further be assessed to classify the paths covered depending on various criteria, such as reliability and quality of the respective location technology, reputation of the source, age, etc. To this end, according to embodiments, means 14 for collecting is adapted to provide the collected location information with reliability information.

In a further sub-step, S24, the collected, filtered and assessed location information corresponding to the paths covered is handed over to a location information sequence management unit. To this end, means 14 for collecting comprises a memory. In embodiments, this may, for example, be a digital memory. Here, the collected, filtered and assessed location information is collected with respect to comparability and access possibilities and managed in an optimized manner. From the (digital) memory, forwarding takes place for the evaluation of the plurality of ways and/or paths covered, beyond separate consideration of individual paths covered.

After collecting S20 the location information 16 in the predetermined region with respect to FIG. 2, overlaying S30 the collected location information with the cartographic data 12 for the predetermined region follows. In a next step S40, there follows determining portions contradictory or missing in the cartographic data 12 for the predetermined region on the basis of the overlaid, collected location information.

An exemplarily flow chart for a combination of steps S30 and S40 is shown schematically in FIG. 3b.

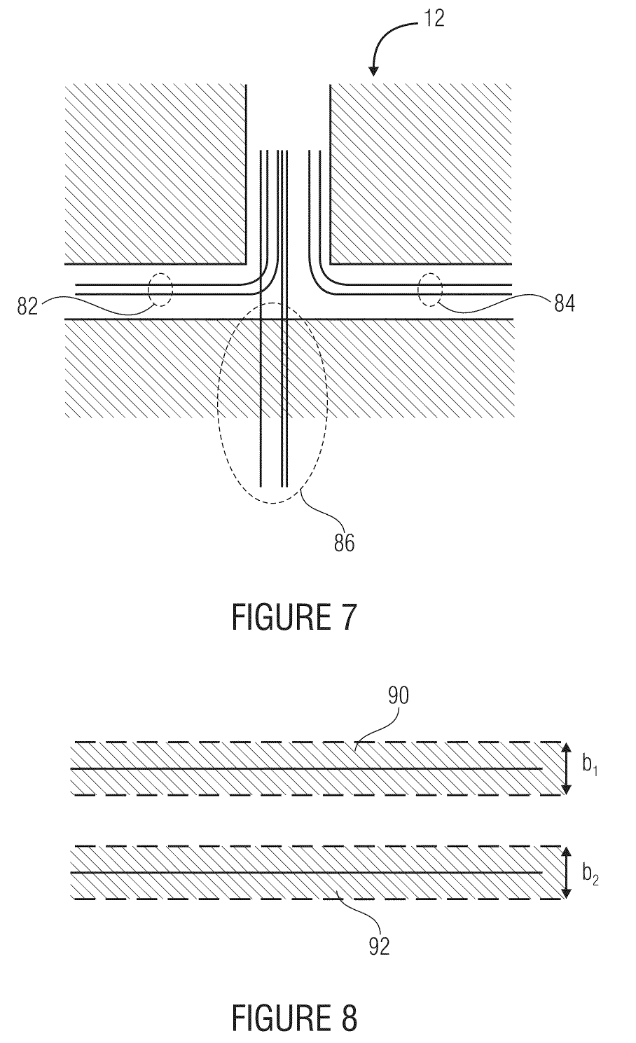

The location information collected and pre-processed in step S20 is present in a kind of raw form in the (digital) memory in which form it may be mapped to a known and/or predetermined region in a sub-step S32. To this end, means 14 for collecting, according to embodiments, is adapted to scale coordinates of the collected location information 16 to the scale of the cartographic data of the predetermined region. Furthermore, in sub-step S32, according to embodiments of the present invention, parts of paths covered and/or paths in regions known to be passable or trafficable can be taken out of further consideration. Of course, the location information corresponding to regions known in the cartographic data 12 can be processed further, which then serves for updating, assessment or enhancement of known data, rather than detailing or supplementing. Sub-step S23 shall be explained in greater detail in the following on the basis of FIG. 7.

FIG. 7 shows known cartographic data 12 for a predetermined region with a plurality of location and/or path information 82, 84, 86 mapped to the cartographic data 12. The path information 82, 84 is mapped entirely to portions (e.g. streets or footpaths) known already. Parts of further path information 86 are in conflict with the existing cartographic data 12 by reaching into portions of the cartographic data 12 previously labeled as not passable and/or trafficable. In sub-step S32, the path information 82, 84 mapped to the known portions of the cartographic data 12 and the corresponding known parts of the path information 86 are not considered any further. That is, these known path segments can be neglected for further consideration for reasons of efficiency. Only the parts of the path information 86 circled in FIG. 7 are considered. According to embodiments, means 18 for overlaying thus is adapted to link the location information corresponding to the paths covered with the cartographic data 12 such that known portions in the location information corresponding to the paths covered remain unconsidered in the cartographic data 12.

If those path segments to be associated with portions missing in the cartographic data 12 or being contradictory have been determined in step S32, these path segments can be projected onto the corresponding portions of the cartographic data 12 in a next sub-step, S34, according to embodiments. To this end, the path segments may, for example, be weighted depending on an assessment performed in sub-step S23 and represented, e.g. as pixel matrices (with and without scattering) or (approximation) functions. Possible embodiments for the weighting will be explained in greater detail in the following on the basis of FIGS. 8-11.

FIG. 8 shows two path segments 90, 92 weighted depending on selectable criteria, such as their reliabilities. In the scenario exemplarily shown in FIG. 8, the path 90 covered was determined with a less reliable location technology than the path 92 covered. Hence, the path 90 covered is imparted with a first location unsharpness function, which leads to a projection of the path 90 covered to the corresponding map portions, which make the path 90 covered appear with a certain width b1 in an unsharpness corridor. In contrast thereto, the path 92 covered, which was recorded with the more accurate location technology, is provided with a second location unsharpness function, so that it is represented by a width b2 on the corresponding map portions in a less wide unsharpness corridor.

According to embodiments, means 18 for overlaying thus is adapted to weight the location information corresponding to the paths covered corresponding to its accuracy and/or reliability with a location unsharpness function, in order to obtain a location probability statement. The projections of the paths covered to the respective map portions may lead to an intended overlay of the paths, particularly in regions corresponding, in reality, to a path covered.

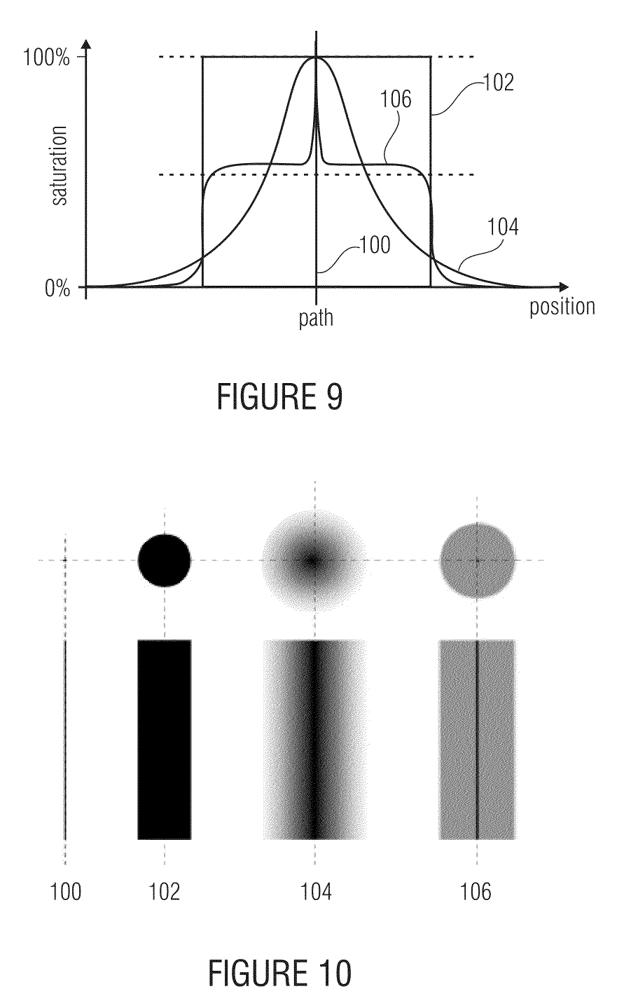

Further embodiments for weighting location information corresponding to paths covered are shown in FIG. 9.

Depending on the original representation of the collected location information and an analysis algorithm, suitable weightings and/or scatterings may be used. FIG. 9 shows possible saturation and/or weighting profiles of the projected position point or position path.

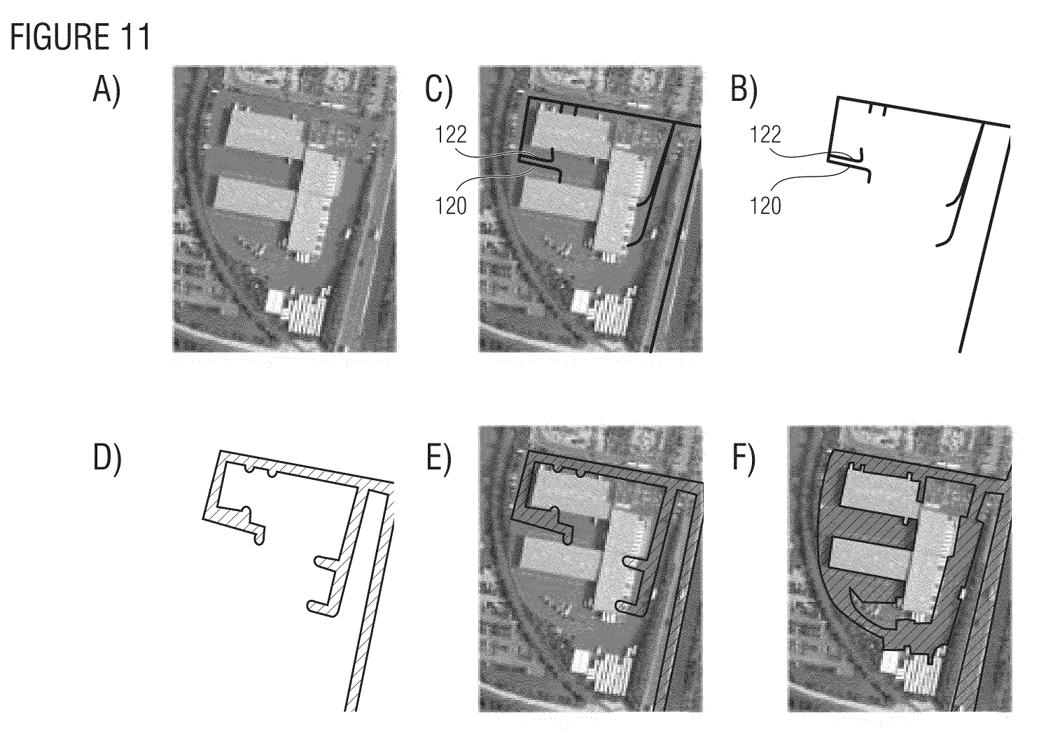

In the saturation profile designated with reference numeral 100, a point [(xᵢ(tₙ), yᵢ(tₙ))] or path [(xᵢ(t₀), yᵢ(t₀)), . . . , (xᵢ(t_{N}), yᵢ(t_{N}))] with maximum saturation is depicted exactly at its location without scattering, as also illustrated in FIG. 10 at reference numeral 100. In the saturation profile designated with reference numeral 102 in FIG. 9, a point [(xᵢ(tₙ), yᵢ(tₙ))] is represented with a sharply drawn circle with the original position as a center, and a path [(xᵢ(t₀), yᵢ(t₀)), . . . , (xᵢ(t_{N}), yᵢ(t_{N}))] correspondingly with a certain width, as also depicted with the reference numeral 102 in FIG. 10. A parabolic saturation characteristic designated by the reference numeral 104 in FIGS. 9 and 11 makes clear a higher weighting of measured positions with respect to a constructed scattering. A characteristic designated by reference numeral 106 in FIGS. 9 and 11 links the previously-mentioned characteristics, wherein a scattering does not possess any sharp boundaries, a plateau-like region takes influence with reduced saturation, and measured values are prominent as fully saturated points and/or lines from the scattering via a peak.

Apart from the previously described characteristics, further forms are possible, of course, such as triangles or trapezoids. One reason for the introduction of a scattering, for example, is closing holes between neighboring paths covered and intercepting inaccuracies, which may develop in a system-induced manner in the location. A maximum saturation level may additionally be changed, e.g. depending on a location reliability or the velocity. Thus, all available points and/or paths in a map portion may be depicted in accordance with this scheme for analysis. Thereupon, frequently used regions may be identified from an overlay.

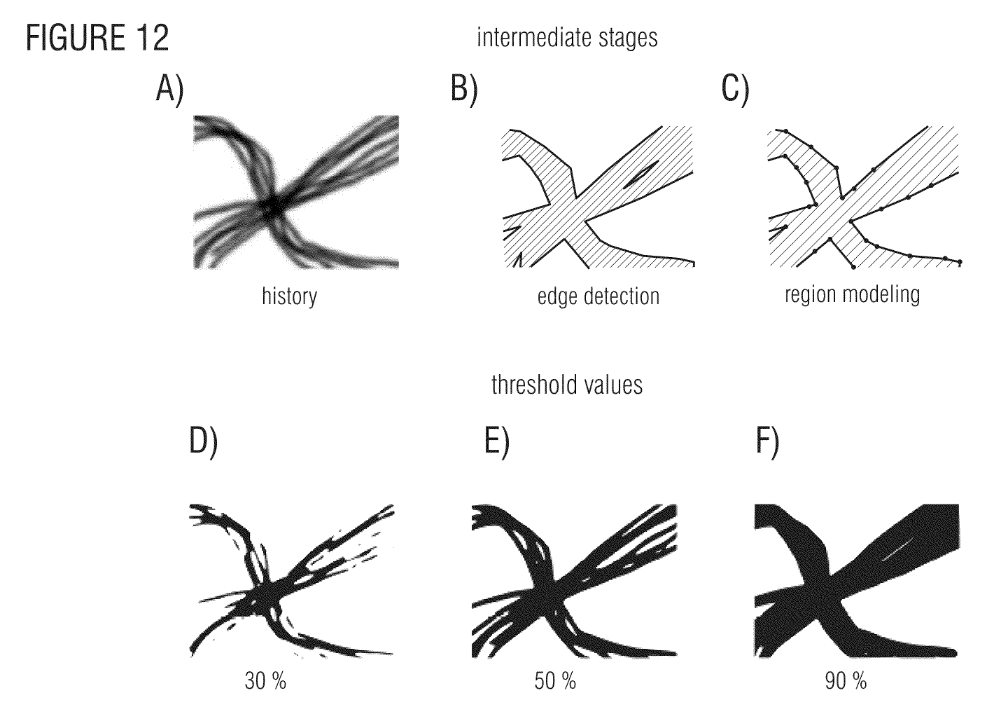

After the weighting and projection of the location information onto corresponding map portions in sub-step S34, there follows a similarity analysis in a next sub-step, S36, according to embodiments, wherein spatially neighboring path segments of similar profile are detected by comparing a plurality of paths covered to each other. To this end, means 20 for determining according to embodiments is adapted to determine similar paths deviating from each other by a maximum tolerance range admissible from collected location information corresponding to a plurality of paths covered. The analysis may be performed in various ways. A first possibility is based on the projection S34 of the location information and ensuing graphical assessment. A plurality of location information corresponding to a plurality of paths covered in a certain map portion are overlaid additively, so that a replica of a complete movement history available is obtained in the map portion. Graded scattering characteristics, in particular, lend themselves here. Holes developing in the case of a simple line illustration thus are closed and neighborhood relations established between paths by way of the overlay, as shown in FIG. 12a.

Contiguous regions may now be determined by way of graphical edge detection, wherein a recognition threshold may be adjusted with respect to the saturation (FIG. 12b). Advantageously, the edges thus detected may, again, be modeled, e.g. as traverses or polygons, as shown in FIG. 12c. This way, holes between neighboring paths can be removed and edges smoothed. The number of paths included, the average saturation, or the distance between the included paths, e.g., may exert some influence on relevance and further processing.

Column-wise consideration is also possible. Here, calculation is done with the points of the paths at a defined section, and the distances among each other are determined. The sections may here take place in various ways, such as paraxially or orthogonally with respect to a reference path. The distances may then quantify a similarity and proximity of paths per section or as a sum, so that path groupings can be derived therefrom.

A further possibility is mathematical analysis. The conversion of location coordinates via simple traverses up to more complex interpolations as already described may serve as a basis here. So as to be able to determine similarities and proximities of paths, different computations may be used. On the basis of continuous functions, e.g. integrals or slopes, absolute values, correlations or even spectral behavior may be examined. This may take place on a global or a temporarily defined, local coordinate system.

FIGS. 12d-12f show how similarities and proximities can be specified and adjusted via different parameterizations. In FIG. 12d, saturation threshold values are adjusted such that only very closely adjacent paths covered are classified into one group, whereas the saturation threshold values for grouping in FIG. 12e are adjusted such that even more distantly adjacent paths covered belong to a common group of paths. Saturation threshold values may, for example, be adjusted depending on velocity. Here, a velocity with which a path was covered can be determined easily from the time stamps for the respective location coordinates. Means 20 for determining is adapted, according to embodiments of the present invention, to determine similar paths deviating from each other by a maximum tolerance range admissible, which is determined by the saturation threshold values, from collected location information corresponding to a plurality of paths covered.

Outliers, which may develop e.g. through errors in the location or produced by users having left common paths, can be filtered out by way of the parameterization.

Following the analysis and grouping of the location information of the paths covered, a sub-step S38 for assessing and classifying the overlaid, collected location information is particularly important for later deciding on a type of feeding the updated cartographic data 12 into a database. In embodiments of the present invention, with reference to FIG. 3b, a cartographic database is used already at the beginning of the location information analysis, which may be summarized by steps S30 and S40, in order to associate the location information with model and/or cartographic data 12 stored in the cartographic database. That is, in steps S30 and S40, the contradictory and/or missing map portions are already identified, and it is thus known at which locations, both geographically and also logically, changes and/or updates shall be incorporated in the cartographic data 12. The classification in sub-step S38 serves to choose the representation matching the data format and change. Here, for example, depending on a width of a path covered and/or a width of a group of neighboring paths covered and/or the velocities at which the paths were covered each, it may be concluded whether a new region is a footpath, cycling path or a street. That is, means 20 for determining is adapted to extract path width and/or path velocity information from the location information and perform classification of the collected location information based thereon. Here, the width of a new path is defined, for example, by a constant distance from the path corresponding to a path covered or a middle path of paths covered. Numerous further possibilities may be applied, for example, such as a region definition about a maximum expanse of the detected, usable area by way of a polygon.

Following steps S30, S40, integration of the information acquired therefrom into the existing cartographic data 12 is needed. To this end, with reference to FIG. 2, the method of updating the cartographic data 12 includes a step S50 of updating the cartographic data 12 in the missing or contradictory portions on the basis of the overlaid collected location information.

With reference to FIG. 3c, step S50 of updating includes a sub-step S52, wherein the new cartographic regions previously classified in the sub-step S38 are suitably represented and dimensioned. In other words, this means that a region classified as a cycling path, for example, is also represented as a cycling path and is also suitably dimensioned. That is, a cycling path will be generally less wide than a multi-lane street with heavy traffic. Representation and dimensioning are followed by a further sub-step, S54, wherein the represented and dimensioned location information is finally labeled correspondingly, for example, logically or graphically, e.g. by color, metadata or other characters, and is finally integrated into the cartographic database to obtain an updated version of the cartographic data 12 on the basis of the previously overlaid and collected location information.

In embodiments of the present invention, an update of the cartographic data 12 takes place only when an update criterion, such as a minimum number of similar paths corresponding to path information not contained in the cartographic data 12, is met. In other words, this means that few similar paths covered may not be sufficient to perform an update, because the few similar paths covered do not yet really guarantee e.g. an actually existing street or the like.

In the following, the inventive concept shall again be illustrated on the basis of FIG. 11.

FIG. 11a shows cartographic data 12 in the form of an aerial photograph for a predetermined region around a storage building. FIG. 11b shows collected location information on paths covered in the predetermined region around the storage building. Here, FIG. 11b only exemplarily shows some, like the two paths 120, 122, each weighted according to one of the patterns described previously. It can be seen that huge areas of the two paths 120, 122 covered overlap. FIG. 11c shows the overlay of the paths covered with the cartographic data 12 for the predetermined region around the storage building. It can be seen therein that a part of the paths 120, 122 covered corresponds to a path on a street, whereas the remaining parts of the paths 120, 122 covered are on the storage premises.

FIG. 11d shows an illustration of the paths 120, 122 covered, wherein a boundary of the region detected through grouping of the paths 120, 122 is illustrated. The new region detected in FIG. 11d, for which further information in the cartographic material is missing, is illustrated as projected onto the photograph in FIG. 11e.

In sub-step S38, which concerns the assessment and classification of the detected region, similar regions in the cartographic data 12 may now be searched for, e.g. in digital photographs, i.e. regions having the same shade of color as the detected region, for example. To this end, means 20 for determining is adapted to determine a passable and/or trafficable area in the predetermined region from the location information and surface condition information from the cartographic data 12. In the example shown in FIG. 11, this leads to an expansion of the detected region by additional asphalt areas on the street and the storage premises. Since there are additional areas in the digital photograph of the same surface condition and/or shade of color as the detected region, one can assume that the additional regions may also be classified as passable and/or trafficable. Thereby, the hatched region depicted in FIG. 11f develops, which can be labeled as passable and/or trafficable in the cartographic data 12 and integrated.

The inventive concept presented previously may be used for achieving various objectives. One obvious example is an update of existing cartographic material, which means that information that is already available is verified. This is done by means of an implicit check by subscribers and the inclusion of changes at run-time. Moreover, the cartographic material may continuously be refined further by performing supplementations. In particular, this relates to regions the usage of which is unknown or inaccurate. Changes in reality, e.g. through construction activity, are also introduced into the cartographic material via adaptive user behavior. Maximum value-added can be obtained when the data thus processed can be utilized by location technology and behavioral history in order to produce cartographic material in a completely new way. In extreme cases, this means that an area of unknown usability is gradually supplemented by information. It may then, again, be made available to various location applications as a map and serve as starting material there. One example is the creation of building or landscape maps, without any further available construction details. Paths, passages, corridors, rooms, etc. can be identified in such a manner.

A further aspect is the matching of movement history and derived usage classification with pixel-based data, usually photographically generated image information. This means that the experience-based location information is combined with e.g. aerial or satellite pictures (in arbitrary frequency ranges). In such a photo or pixel matching, the two information levels, image and location information, are overlaid and then matched. Thus, on the basis of the photographs, e.g. boundary regions of analytically determined regions can be specified. Furthermore, errors may also be identified and removed from colors, color transitions and textures. Likewise, estimation of potentially usable regions for which there no position history is available yet is also possible. This is done via the similarity to the already linked (matched) regions.

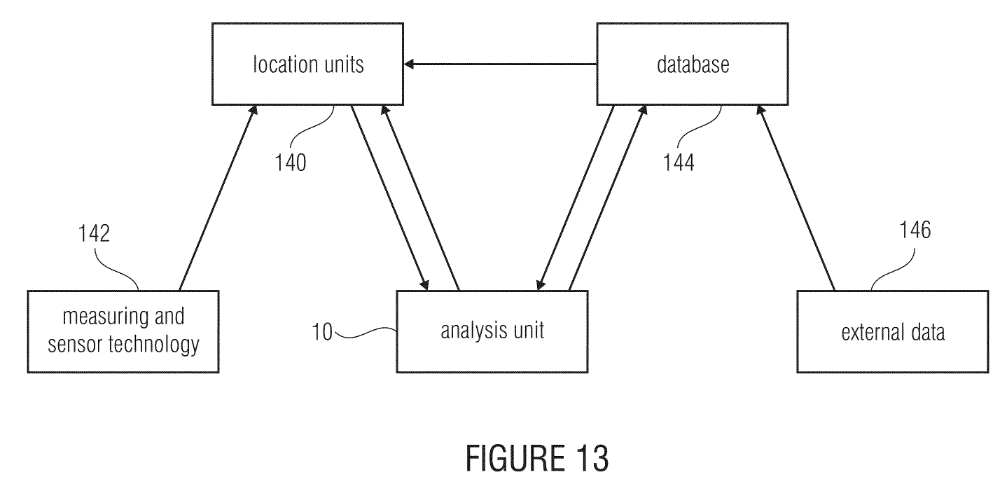

In summary, on the basis of FIG. 13, the employment of the inventive concept in a navigation and/or location system shall be illustrated once again.

Position sequences [(xᵢ(t₀), yᵢ(t₀)), . . . , (xᵢ(t_{N}), yᵢ(t_{N}))] are generated by mobile subscribers and/or their associated location units 140 by means of measurement and sensor technology 142. The temporal and spatial reference of the positions of the position sequences with respect to each other and between these dimensions (time, space) allows for representing the respective paths covered. These paths covered are collected by the device 10 and processed further so as to link them with existing information on the surroundings from a database 144. Here, the database 144 may be fed and/or updated with external data 146 in advance or additionally. In the device 10, e.g. rendition, maybe a normalization of geographical and temporal kind, evaluation with respect to source and quality of the collected location information, and maybe further steps take place, depending on the embodiment of the present invention. Furthermore, the location information thus collected is analyzed by grouping and identifying typical paths covered with a certain parameterization. Influential quantities here are, e.g., number, velocity, direction and/or path profile, location technology, spatial and temporal distance. Thus, paths covered in a region can be recognized and labeled in an adjustable way within certain boundaries and sharpnesses, whereupon classification may take place, which classifies the determined character with respect to the repercussion on the cartographic material of the database 144. The previously mentioned evaluation serves as a basis for representing the newly acquired information in various ways in the database 144. For example, it may thus be determined whether a street of a certain basic extension or a footpath is modeled as an unstructured, passable area. The reliability of the new data may also be retained and serve as indication of the origin for further processing.

The entire approach becomes particularly relevant when regarded as a self-learning method, i.e. runs cyclically and evaluates automatically, and incorporates according to the above-described procedure, any new information provided from mobile units.

Embodiments of the present invention utilize the behavior of users. This means that people or vehicles generally use passable or trafficable areas. In vehicle navigation, for example, determined positions are projected onto the most probable street in the proximity, even in the case of slight deviations (so-called Map Matching). This increases the calmness and trustworthiness of the visualization. If it is assumed, in reverse, that a large part of the mobile users avoid obstacles and follow given and/or prescribed paths, information on these paths covered can be coupled to the cartographic material by embodiments of the present invention. In addition, unknown or changed paths can also be detected with embodiments of the present invention, with no information in this respect having been present previously. One example is a footpath through a park that is usually used by a large part of the people moving about there, but usually not deposited in cartographic databases.

In particular, it is pointed out that, depending on the circumstances, the inventive scheme may also be implemented in software. The implementation may be on a digital storage medium, particularly a disk or CD with electronically readable control signals capable of co-operating with a programmable computer system and/or microcontroller so that the corresponding method is executed. In general, the invention thus also consists in a computer program product with a program code stored on a machine-readable carrier for performing the inventive method of updating cartographic data, when the computer program product is executed on a computer and/or microcontroller. In other words, the invention may thus be realized as a computer program with a program code for performing the method of updating cartographic data, when the computer program is executed on a computer and/or microcontroller.

Furthermore, it is pointed out that the present invention is not limited to the respective components of the device 10 or the explained procedure, for these components and methods may vary. The terms used here are only intended for describing particular embodiments and are not used in a limiting sense. When using the singular or indefinite articles in the description and in the claims, these also refer to the plurality of these elements unless clearly dictated otherwise by the overall context. The same applies vice-versa.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1-20. (canceled)

21. A device for updating cartographic data for a predetermined region, comprising:
a collector for collecting location information of a path covered in the predetermined region, wherein the collector is formed to provide the collected location information with reliability information;
an overlayer for overlaying the collected location information with the cartographic data for the predetermined region, wherein the overlayer is formed to weight the location information that corresponds to the paths covered corresponding to selectable criteria, wherein each coordinate of the location information is weighted with a location unsharpness function for weighting to acquire a location probability statement in form of an unsharpness corridor corresponding to the path covered;
a determiner for determining portions contradictory or missing in the cartographic data for the predetermined region on the basis of the overlaid collected location information, wherein the determiner is formed to determine similar paths deviating from each other by a maximum tolerance range admissible from collected location information corresponding to a plurality of paths covered, and wherein contiguous regions are determined by overlaying unsharpness corridors corresponding to the similar paths and ensuing edge detection; and
an updater for updating the cartographic data in the missing or contradictory portions on the basis of the overlaid, collected location information.

22. The device according to claim 21, wherein the cartographic data are digital cartographic data.

23. The device according to claim 21, wherein the collector for collecting the location information is formed to collect the location information on the basis of radio signals.

24. The device according to claim 21, wherein the collector is coupled to a WLAN transceiver.

25. The device according to claim 21, wherein the location information comprises location coordinates, time information, and a transceiver tag.

26. The device according to claim 21, wherein the collector is formed to scale coordinates of the collected location information to the predetermined region.

27. The device according to claim 21, wherein the collector comprises a renderer for rendering the collected location information.

28. The device according to claim 27, wherein the renderer comprises a filter for smoothing the location information corresponding to the paths covered.

29. The device according to claim 21, wherein the collector comprises a digital memory to store and manage the collected location information.

30. The device according to claim 21, wherein the overlayer is formed to link the location information corresponding to the paths covered with the cartographic data, so that known portions in the cartographic data remain unconsidered in the location information corresponding to the paths covered.

31. The device according to claim 21, wherein the determiner is formed to extract path widths and/or path velocity information from the location information and perform classification of the collected location information on the basis thereof.

32. The device according to claim 21, wherein the determiner is formed to determine a passable and/or trafficable area in the predetermined region from the location information and surface condition information from the cartographic data.

33. The device according to claim 21, wherein the updater is formed to perform an update of the cartographic data only if an update criterion is met.

34. The device according to claim 33, wherein the update criterion comprises a minimum number of similar paths corresponding to path information not comprised in the cartographic data.

35. A method of updating cartographic data for a predetermined region, comprising:
collecting location information of a path covered in the predetermined region, wherein the collected location information is provided with reliability information;
overlaying the collected information with the cartographic data for the predetermined region, wherein the location information that corresponds to a path covered is weighted corresponding to the reliability information, wherein each coordinate of the location information is weighted with a location unsharpness function for weighting to acquire a location probability statement in form of an unsharpness corridor corresponding to the path covered;
determining portions contradictory or missing in the cartographic data for the predetermined region on the basis of the overlaid, collected location information, wherein similar paths deviating from each other by a maximum tolerance range admissible are determined from location information corresponding to a plurality of paths covered, and wherein contiguous regions are determined by overlaying unsharpness corridors corresponding to the similar paths and ensuing edge detection; and
updating the cartographic data in the missing or contradictory portions on the basis of the overlaid collected location information.

36. A tangible computer readable medium including a computer program for performing, when the computer program is executed on a computer and/or microcontroller, a method of updating cartographic data for a predetermined region, the method comprising:
collecting location information of a path covered in the predetermined region, wherein the collected location information is provided with reliability information;
overlaying the collected information with the cartographic data for the predetermined region, wherein the location information that corresponds to a path covered is weighted corresponding to the reliability information, wherein each coordinate of the location information is weighted with a location unsharpness function for weighting to acquire a location probability statement in form of an unsharpness corridor corresponding to the path covered;
determining portions contradictory or missing in the cartographic data for the predetermined region on the basis of the overlaid, collected location information, wherein similar paths deviating from each other by a maximum tolerance range admissible are determined from location information corresponding to a plurality of paths covered, and wherein contiguous regions are determined by overlaying unsharpness corridors corresponding to the similar paths and ensuing edge detection; and
updating the cartographic data in the missing or contradictory portions on the basis of the overlaid collected location information.
